(19) United States
(12) Patent Application Publication
(10) Pub. No.: US 2021/0381273 A1
(43) Pub. Date: Dec. 9, 2021

(54) NO-CONTACT TOOL TO FACILIATE NO-CONTACT ACTIVITIES

(71) Applicants: Paul Banchitta, (US); Christopher Chieco, (US)

(72) Inventors: Paul Banchitta, Howard Beach, NY (US); Christopher Chieco, Brooklyn, NY (US)

(21) Appl. No.: 16/896,975

(22) Filed: Jun. 9, 2020

(51) Int. Cl. E05B 1/00

(52) U.S. Cl. CPC E05B 1/0053; E05B 1/0069

(57) ABSTRACT

A tool for facilitating no-contact activities includes a first manipulation member having a curvilinear edge defining a first surface and an opposing second surface. The curvilinear edge is provided with a plurality of bump surfaces. A second manipulation member extends outwardly of the first manipulation member, and a third manipulation member extends from the second manipulation member. The third manipulation member includes at least one hook element. One of the first manipulation member and the second manipulation member includes an accessory mount that is configured to detachably receives a no-contact accessory.

### INTRODUCTION

The subject disclosure relates to no-contact tools and, more particularly, to a no-contact tool that facilitates no-contact activities.

Undesirable organisms, those that might cause harm to humans, are becoming ubiquitous. Organisms such as viruses, bacteria, molds, and the like may exist on surfaces for prolonged periods. The organisms may be unintentionally deposited on a surface through various mechanisms including touching, an expression of bodily fluids by sneezing or coughing or the like. Given the potential for these undesirable organisms to exist on any surface there is a need for a no-touch system for interacting with various surfaces.

Currently, many people are using disposable gloves to interact with various surfaces. While effective, the gloves must be disposed of properly, and may not allow a person to interact with many touch screen devices that require a conductive interface such as a finger. Other devices have been developed that allow a user to interact with various devices including push buttons, doors handles, and the like. The devices or tools may be formed from plastic or brass.

The tools, while effective at pushing buttons, doors and the like, leave much to be desired when interacting with touch screen devices, door locks, and certain door handles. Accordingly, it is desirable to provide a tool that increases interaction with various devices including, for example, dead bolt lock mechanisms, lever door handles, touch screen devices and the like without requiring physical contact.

### SUMMARY

In one exemplary embodiment, a tool for facilitating no-contact activities includes a first manipulation member having a curvilinear edge defining a first surface and an opposing second surface. The curvilinear edge is provided with a plurality of bump surfaces. A second manipulation member extends outwardly of the first manipulation member, and a third manipulation member extends from the second manipulation member. The third manipulation member includes at least one hook element. One of the first manipulation member and the second manipulation member includes an accessory mount that is configured to detachably receives a no-contact accessory.

In addition to one or more of the features described above or below, or as an alternative, further embodiments could include wherein the accessory mount provides an electrical interface between the no-contact accessory and the first, second, and third manipulation members.

In addition to one or more of the features described above or below, or as an alternative, further embodiments could include wherein the accessory mount includes a plurality of threads.

In addition to one or more of the features described above or below, or as an alternative, further embodiments could include wherein the no-contact accessory comprises a stylus tip.

In addition to one or more of the features described above or below, or as an alternative, further embodiments could include wherein the stylus tip is electrically conductive.

In addition to one or more of the features described above or below, or as an alternative, further embodiments could include wherein the first manipulation member includes a manipulation ring extending through the first surface and the second surface, the manipulation ring defining an opening having a substantially continuous surface.

In addition to one or more of the features described above or below, or as an alternative, further embodiments could include a plurality of openings extending about the manipulation ring through the first surface and the second surface, at least three of the plurality of openings defining a corresponding one of the plurality of bump surfaces.

In addition to one or more of the features described above or below, or as an alternative, further embodiments could include wherein the plurality of surfaces includes at least a first bump surface, a second bump surface, a third bump surface, a fourth bump surface, and a fifth bump surface.

In addition to one or more of the features described above or below, or as an alternative, further embodiments could include wherein the first bump surface defines a first bump radius, the second bump surface defines a second bump radius, the third bump surface defines a third bump radius, the fourth bump surface defines a fourth bump radius, and the fifth bump surface defines a fifth bump radius.

In addition to one or more of the features described above or below, or as an alternative, further embodiments could include wherein at least one of the first, second, third, fourth, and fifth bump radii includes a curvature that is distinct from other of the first, second, third, fourth, and fifth bump radii.

In addition to one or more of the features described above or below, or as an alternative, further embodiments could include wherein the first manipulation member includes at least one manipulation groove extending into one of the first, second, third, fourth, and fifth bump surfaces from the curvilinear edge.

In addition to one or more of the features described above or below, or as an alternative, further embodiments could include wherein the at least one manipulation groove includes a first manipulation groove having a first radius extending into the one of the first, second, third, fourth, and fifth bump surfaces from the curvilinear edge and a second manipulation groove having a second radius.

In addition to one or more of the features described above or below, or as an alternative, further embodiments could include that is distinct from the first radius of the first manipulation groove.

In addition to one or more of the features described above or below, or as an alternative, further embodiments could include wherein the at least one hook element includes a first hook element extending relative to the second manipulation member in a first direction and a second hook element extending relative to the second manipulation member in a second direction that is opposite the first direction.

In addition to one or more of the features described above or below, or as an alternative, further embodiments could include wherein the first hook element includes a hook surface and a manipulation surface having bump radius arranged opposite the hook surface.

In addition to one or more of the features described above or below, or as an alternative, further embodiments could include a manipulation groove extending into the manipulation surface.

In addition to one or more of the features described above or below, or as an alternative, further embodiments could include wherein the manipulation surface includes a bump tip.

In addition to one or more of the features described above or below, or as an alternative, further embodiments could include wherein the second hook element defines a bottle opener.

In addition to one or more of the features described above or below, or as an alternative, further embodiments could include wherein the second manipulation member includes a first substantially linear edge extending from the first manipulation member to the first hook element, and a second, opposing edge that extends from the first manipulation member to the second hook element, the second edge having a projection that forms part of the bottle opener.

In addition to one or more of the features described above or below, or as an alternative, further embodiments could include wherein the no-contact accessory mount recess is formed in the third manipulation member between the first hook element and the second hook element.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a right perspective view of a no-contact tool that facilitates no-contact activities, in accordance with an exemplary aspect;

FIG. 2 is a plan view of the no-contact tool of FIG. 1, in accordance with an exemplary aspect;

FIG. 3 depicts the no-contact tool being employed to manipulate a door lock;

FIG. 4 depicts the no-contact tool being employed to manipulate a dead bolt actuator;

FIG. 5 depicts the no-contact tool being employed to manipulate a door handle;

FIG. 6 depicts the no-contact tool being employed to manipulate a knob; and

FIG. 7 depicts the no-contact tool being employed to manipulate a pull chain.

### DETAILED DESCRIPTION

The following description is merely exemplary in nature and is not intended to limit the present disclosure, its application or uses. It should be understood that throughout the drawings, corresponding reference numerals indicate like or corresponding parts and features.

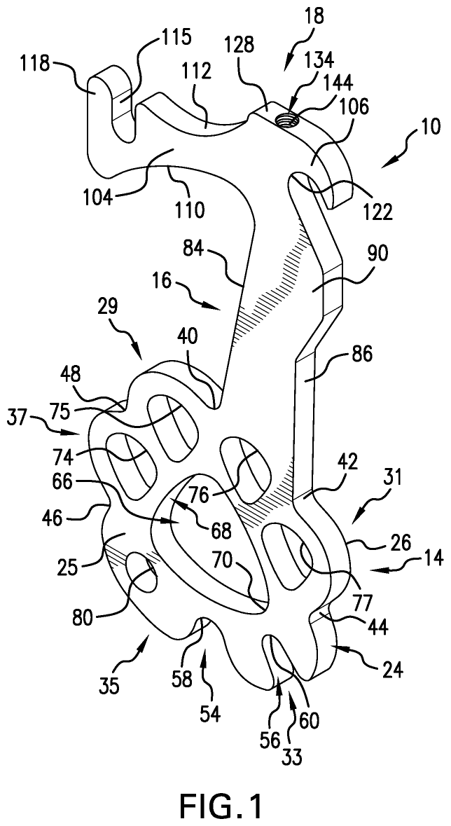

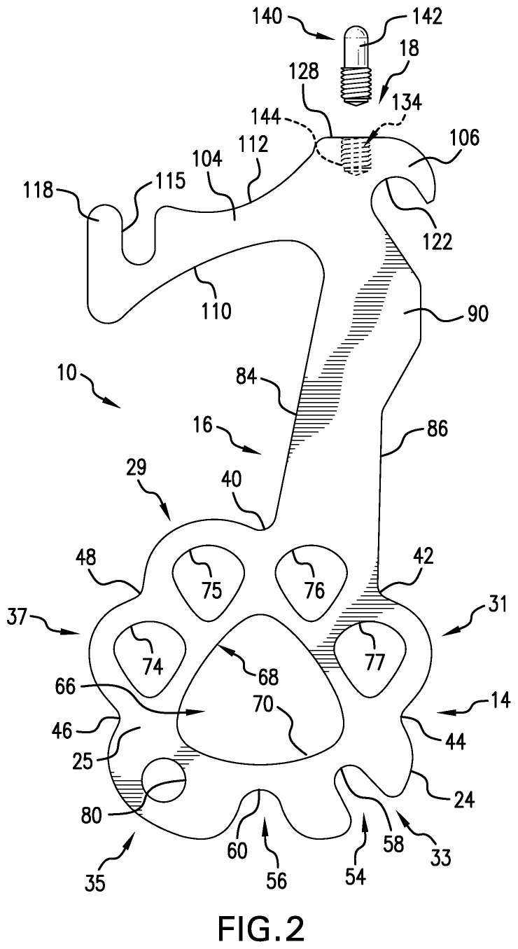

A non-contact tool, in accordance with an exemplary aspect, is indicated at 10 in FIGS. 1 and 2. No-touch tool 10 is used by an individual to interact with various devises, surfaces, and the like without having to make actual physical contact. No-touch tool 10 includes a first manipulation member 14, a second manipulation member 16, and a third manipulation member 18.

First, second, and third manipulation members 14, 16, and 18 are integrally formed forming a unitary or one-piece body. As will become readily apparent, a user may employ first, second, and third manipulation members 14, 16, and 18 either individually or in combination to manipulate various items one might encounter in any given day without the need for actual physical contact. In an embodiment, no-contact tool 10 is formed from brass. It should however be understood that various other materials may be employed.

In an embodiment, first manipulation member 14 includes a curvilinear edge 24 defining a first surface 25 and a second surface 26. Curvilinear edge 24 extends continuously about no-contact tool 10 such that first and second surfaces 25 and 26 also define exterior surfaces of second manipulation member 16 and third manipulation member 18. For first manipulation member 14, curvilinear edge 24 defines a first bump surface 29, a second bump surface 31, a third bump surface 33, a fourth bump surface 35, and a fifth bump surface 37.

In an embodiment, a first bump radius 40 is defined between first bump surface 29 and second manipulation member 16. A second bump radius 42 is defined between second manipulation member 16 and second bump surface 31. A third bump radius 44 is defined between second bump surface 31 and third bump surface 33. A fourth bump radius 46 is defined between fourth bump surface 35 and fifth bump surface 37, and a fifth bump radius 48 defined between fifth bump surface 37 and first bump surface 29.

First manipulation member 14 also includes a first manipulation groove 54 and a second manipulation groove 56. First manipulation groove 54 extends from curvilinear edge 24 into third bump surface 33 and includes a first radius 58. Second manipulation groove 56 extends from curvilinear edge 24 inwardly between third bump surface 33 and fourth bump surface 35. Each bump radius 40, 41, 43, 45, and 47 may have a different curvature so as to provide various options for non-contact interaction with devices and/or surfaces. To provide additional flexibility for manipulating devices, first radius 58 of first manipulation groove 54 may have a curvature that is different than second radius 60 of second manipulation groove 56.

In further accordance with an exemplary aspect, first manipulation member 14 includes a manipulation ring 66 that extends through first and second surfaces 25 and 26 and which is surrounded by first, second, third, fourth, and fifth bump surfaces 29, 31, 33, 35, and 37. Manipulation ring 66 takes the form of an opening 68 having a contoured or lobed surface 70 that may be employed to interact with and rotate various devise including lock members, various knobs, and the like.

Manipulation ring 66 is also flanked by a plurality of openings including a first opening 74, a second opening 75, a third opening 76, and a fourth opening 77. Openings 74-77 may extend into corresponding ones of fifth bump surface 37, first bump surface 29 second manipulation member 16 and second bump surface 31. Openings 74-77 may be sized so as to engage a variety of fastener sizes and thus be used to rotate a bolt and/or nut having a selected dimension. Further, openings 74-77 may be used as storage for accessories as will be detailed herein. Additionally, another opening 80 may be provided in first manipulation member 14. Opening 80 may be employed to connect no-contact tool 10 with, for example, a key chain (not shown).

Second manipulation member 16 extends between first manipulation member 14 and third manipulation member 18. Second manipulation member 16 includes a first edge 84 and an opposing second edge 86. First and second edges 84 and 86 form a segment of curvilinear edge 24. In an embodiment, first edge 84 is substantially linear and second edge 86 includes a projection 90 that may cooperate with first manipulation member 14 and/or third manipulation member 18 to facilitate contactless operation of devices.

In an embodiment, third manipulation member 18 includes a first hook element 104 extending relative to second manipulation member 16 in a first direction and a second hook element 106 extending relative to second manipulation member 16 in a second direction opposite the first direction. First hook element 104 includes a hook surface 110 that may be employed to exert a pulling force, and a manipulation surface 112 that may be employed to exert a pushing force. Hook surface 110 may also cooperate with, for example, first bump surface 29 and/or first edge 84 to facilitate a rotational force. Further, first and/or second hook elements 104 and 106 may be designed with a selectively exposable cutting edge that can be used to, for example, cut through a seatbelt.

Manipulation surface 112 includes a manipulation groove 115 that may be employed to engage with and motivate various devices. Manipulation groove 115 defines, at least in part, a bump tip 118 that may be employed to push on surfaces such as doors, windows, buttons and the like. Second hook element 106 may define a bottle opener 122. That is, second hook element 106 may be employed, with projection 90 to open bottles.

In accordance with an exemplary aspect, third manipulation member 18 also includes an outwardly facing surface 128 having an accessory mount 134. Accessory mount 134 may receive, for example, a non-contact accessory 140 such as a conductive stylus 142 shown in FIG. 2. Conductive stylus 142 may be used to allow a user to interact with a touch screen device. Toward that end, an electrically conductive path is provided between conductive stylus 142 and first, second, and third manipulation members 14, 16, and 18.

In an embodiment, accessory mount 134 may take the form of a threaded recess 144 that establishes a mechanical connection with non-contact accessory 140. However, it should be understood that various other systems and configurations, such as magnetic connections, twist lock connections, projections, and the like may also be employed. Further, while shown as having a generally circular cross-section, it should be understood that the shape of the accessory mount 134 may vary.

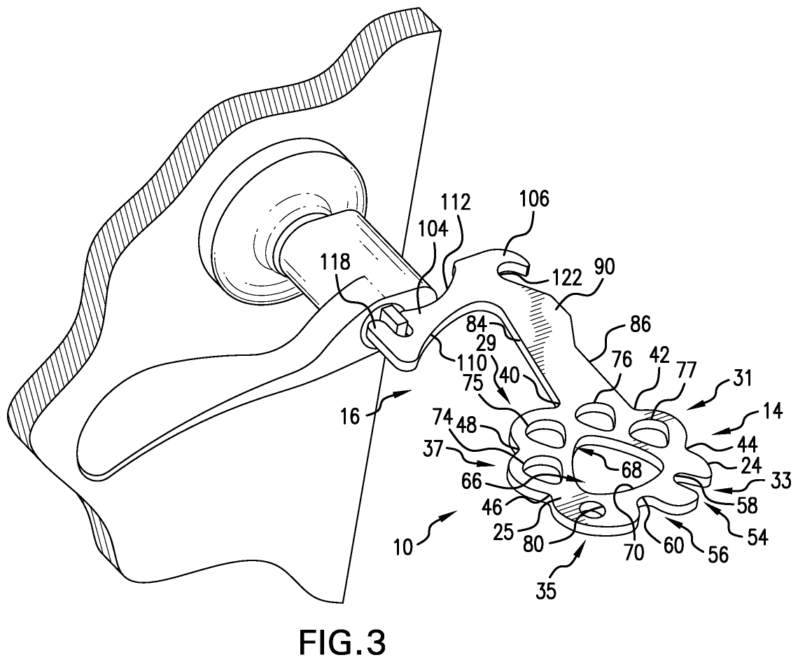

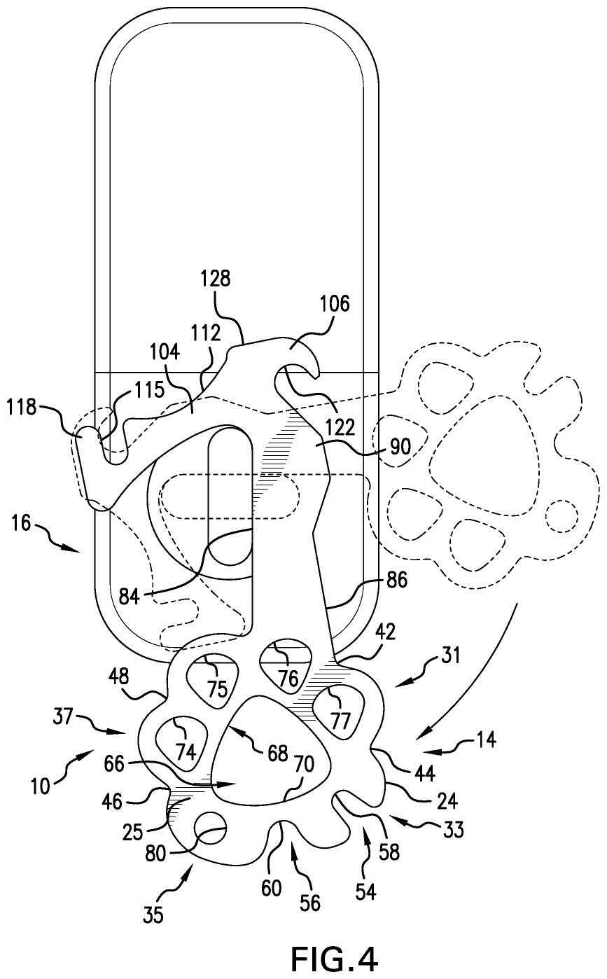

In operation, no-contact tool 10 may be employed to manipulate and/or interact with a wide array of devices. For example, conductive stylus may be used to interact with a touch screen display. Further no-contact tool 10 may be employed to manipulate a door lock such as shown in FIG. 3. Manipulation groove 15 may be placed over a lock actuator and no-contact tool 10 manipulated to lock and/or unlock the door lock. FIG. 4 depicts no-contact tool 10 with a dead bolt tumbler arranged along first edge 84 of second manipulation member 16. The dead bolt tumbler may be engaged by hook surface 110 and rotated with first edge 84 providing a desired support.

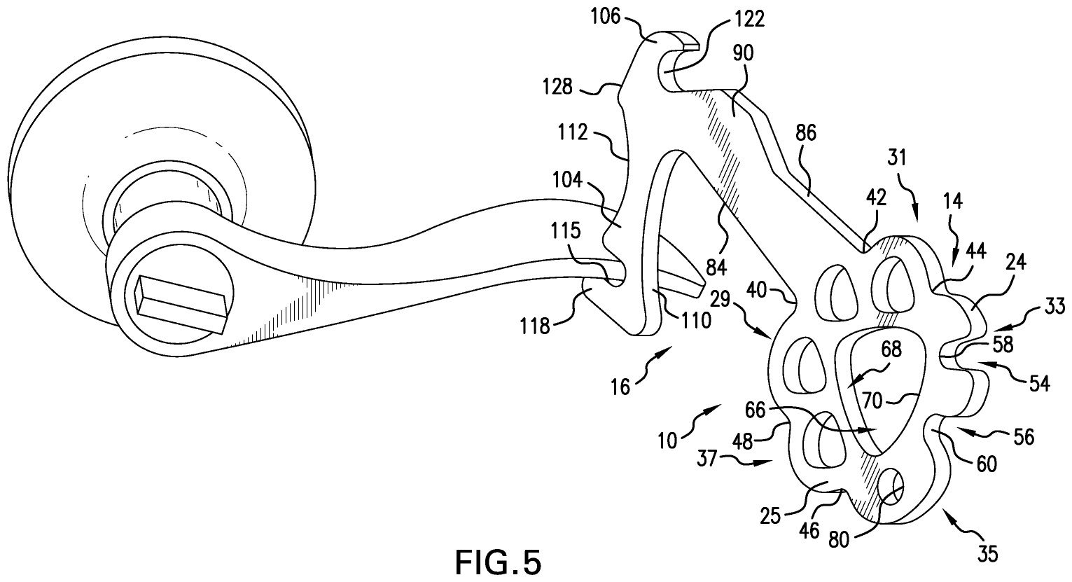

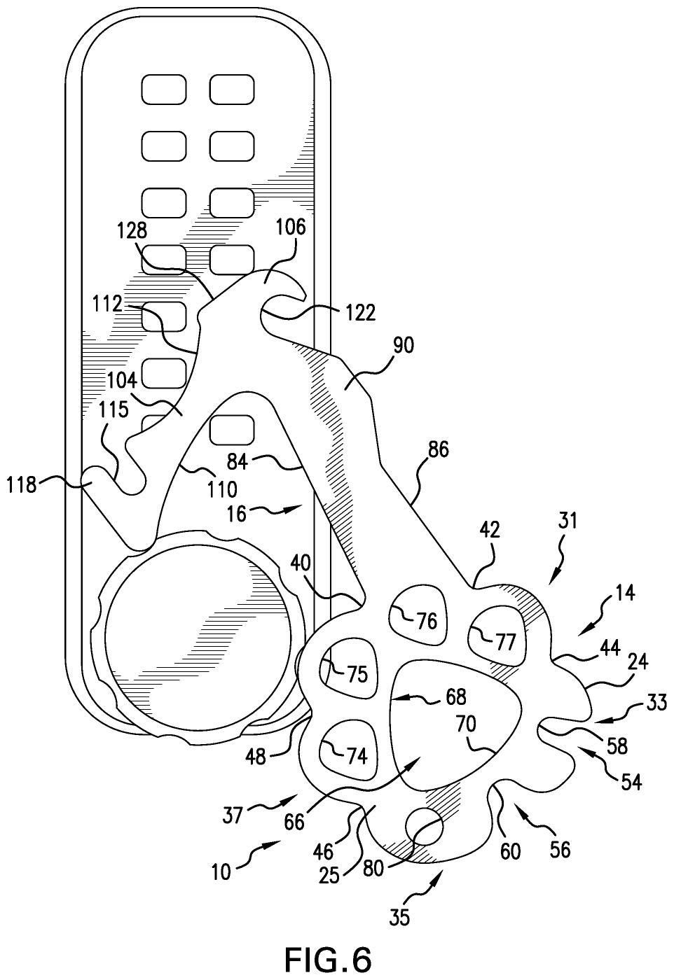

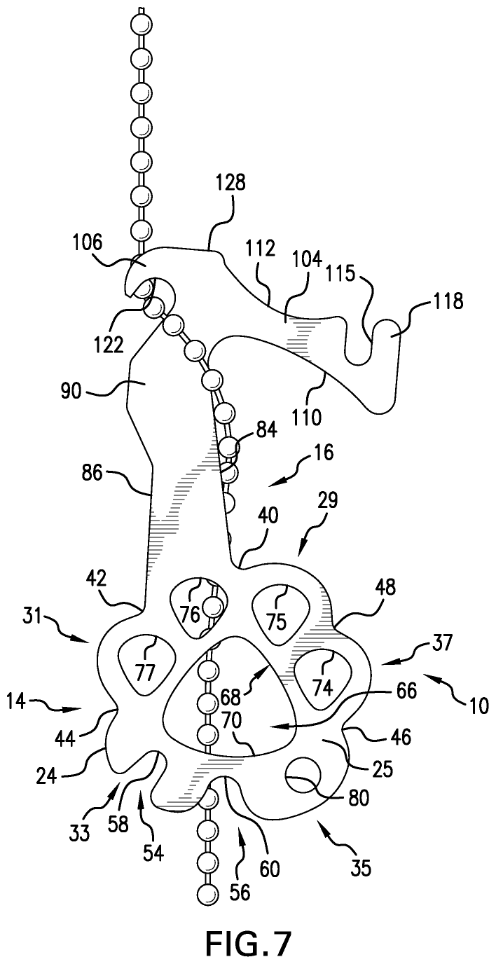

FIG. 5 depicts manipulation groove 115 being used to interact with a door handle. It should be understood that manipulation grooves 54 and 56 may also be used in a similar manner. FIG. 6 depicts hook surface 110 and first bump surface 29 cooperating to manipulate a rotary knob. Finally, FIG. 7 depicts no-contact tool 10 being used to interact with and manipulate a pull chain such as may be found on a window shade, a lamp, a fan and the like.

It should be appreciated that the number of uses for the no-contact tool may be limitless. That is, uses for no-contact tool 10 may only be limited by a user's imagination. Further, by providing an accessory mount, a user may be given a wide range of accessories that may be coupled to the no-contact tool in, for example, openings 74-77. The accessories may include a stylus, a laser pointer, a pen nib, a screwdriver bit, a blade, or any other such device. By providing numerous and wide-ranging options as accessories, the need for a user to interact with multiple devices is eliminated. A person need not use tools or contact and/or manipulate surfaces that may have been touched by others. In this regard, the no-contact tool gives a user a degree of separation from germs and/or viruses that may exist on public and private surfaces.

The terms “about” and “substantially” are intended to include the degree of error associated with measurement of the particular quantity based upon the equipment available at the time of filing the application. For example, “about” and “substantially” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A tool for facilitating no-contact activities comprising:
a first manipulation member including a curvilinear edge defining a first surface and an opposing second surface, the curvilinear edge being provided with a plurality of bump surfaces;
a second manipulation member extending outwardly of the first manipulation member; and
a third manipulation member extending from the second manipulation member, the third manipulation member including at least one hook element, wherein one of the first manipulation member and the second manipulation member includes an accessory mount that is configured to detachably receives a no-contact accessory.

2. The tool according to claim 1, wherein the accessory mount provides an electrical interface between the no-contact accessory and the first, second, and third manipulation members.

3. The tool according to claim 2, wherein the accessory mount includes a plurality of threads.

4. The tool according to claim 1, wherein the no-contact accessory comprises a stylus tip.

5. The tool according to claim 4, wherein the stylus tip is electrically conductive.

6. The tool according to claim 1, wherein the first manipulation member includes a manipulation ring extending through the first surface and the second surface, the manipulation ring defining an opening having a substantially continuous surface.

7. The tool according to claim 6, further comprising a plurality of openings extending about the manipulation ring through the first surface and the second surface, at least three of the plurality of openings defining a corresponding one of the plurality of bump surfaces.

8. The tool according to claim 1, wherein the plurality of surfaces includes at least a first bump surface, a second bump surface, a third bump surface, a fourth bump surface, and a fifth bump surface.

9. The tool according to claim 8, wherein the first bump surface defines a first bump radius, the second bump surface defines a second bump radius, the third bump surface defines a third bump radius, the fourth bump surface defines a fourth bump radius, and the fifth bump surface defines a fifth bump radius.

10. The tool according to claim 9, wherein at least one of the first, second, third, fourth, and fifth bump radii includes a curvature that is distinct from other of the first, second, third, fourth, and fifth bump radii.

11. The tool according to claim 8, wherein the first manipulation member includes at least one manipulation groove extending into one of the first, second, third, fourth, and fifth bump surfaces from the curvilinear edge.

12. The tool according to claim 11, wherein the at least one manipulation groove includes a first manipulation groove having a first radius extending into the one of the first, second, third, fourth, and fifth bump surfaces from the curvilinear edge and a second manipulation groove having a second radius.

13. The tool according to claim 12, wherein the second radius of the second manipulation groove has a curvature that is distinct from the first radius of the first manipulation groove.

14. The tool according to claim 1, wherein the at least one hook element includes a first hook element extending relative to the second manipulation member in a first direction and a second hook element extending relative to the second manipulation member in a second direction that is opposite the first direction.

15. The tool according to claim 14, wherein the first hook element includes a hook surface and a manipulation surface having bump radius arranged opposite the hook surface.

16. The tool according to claim 15, further comprising: a manipulation groove extending into the manipulation surface.

17. The tool according to claim 15, wherein the manipulation surface includes a bump tip.

18. The tool according to claim 14, wherein the second hook element defines a bottle opener.

19. The tool according to claim 18, wherein the second manipulation member includes a first substantially linear edge extending from the first manipulation member to the first hook element, and a second, opposing edge that extends from the first manipulation member to the second hook element, the second edge having a projection that forms part of the bottle opener.

20. The tool according to claim 14, wherein the no-contact accessory mount recess is formed in the third manipulation member between the first hook element and the second hook element.
